(19) United States
(12) Patent Application Publication
(10) Pub. No.: US 2009/0257365 A1
(43) Pub. Date: Oct. 15, 2009

(54) METHOD OF DISTRIBUTING FILES OVER NETWORK

(76) Inventors: Tae In HWANG, Daejeon (KR); Ho Jin PARK, Daejeon (KR); Chunglae CHO, Gainesville, FL (US); Ye XIA, Gainesville, FL (US); Xiaoying ZHENG, Gainesville, FL (US)

Correspondence Address: LADAS & PARRY LLP, 224 SOUTH MICHIGAN AVENUE, SUITE 1600, CHICAGO, IL, 60604, US

(21) Appl. No.: 12/420,899

(22) Filed: Apr. 9, 2009

(30) Foreign Application Priority Data
Apr. 11, 2008 (KR) 10-2008-0033650
Sep. 26, 2008 (KR) 10-2008-0094879

(51) Int. Cl. H04L 12/28

(52) U.S. Cl. 370/256

(57) ABSTRACT

The present invention discloses a method of distributing files over a network, which can attain a proper balance of transfer rates of active spanning trees used between a transmitting node and a receiving node and minimize the time taken for transferring a large file in a P2P (Peer-to-Peer) environment by forming an optimal set of distribution trees with reference to the link costs between the transmitting node and the receiving node and distributing chunk files through the optimal set of distribution trees. The method comprises the steps of: forming a set of spanning trees between a transmitting node and a receiving node and forming a minimum cost tree group by the sum of the link costs of links constituting each of the spanning trees; adjusting the transfer rate of each spanning tree belonging to the minimum cost tree group in accordance with the link cost of each spanning tree belonging to the minimum cost tree group; and transferring chunk files through the spanning trees whose transfer rate is adjusted.

### CROSS-REFERENCE TO RELATED APPLICATION

This application claims the benefit of Korean Application No. 2008-0094879 filed on Sep. 26, 2008 in the Korean Intellectual Property Office, the disclosure of which is incorporated by reference.

This application claims the benefit of Korean Application No. 2008-0033650, field on Apr. 11, 2008 in the Korean Intellectual Property Office, the disclosure of which is incorporated herein by reference.

### BACKGROUND OF THE INVENTION

1. Field of the Invention

The present invention relates to a method of distributing files over a network, and more particularly, to a method of distributing files over a network which detects a minimum spanning tree group by the link cost of each link located between a transmitting node and a receiving node and reduces the time and network load consumed for file transfer.

2. Discussion of the Related Art

In order to transfer a file via a network, there has been widely used a method of transferring chunk files for a file by using trees located between a transmitting node and a receiving node. Typically, fastreplica, Bullet, Chunkcast, and splitstream are widely used.

The fastreplica is a method of dividing a file in one server node into several segments and distributing each of the file segments to a set of client nodes. The fastreplica method provides a simple distribution path because each of the file segments is directly distributed to client nodes, and is efficient when the number of client nodes is small. However, if the number of client nodes is over a threshold value, there is no proper solution of how to select each client group.

The Bullet method suggests a method of distributing file segments by using an underlying P2P overlay tree structure and an additional mesh structure. The Bullet method allows server peers at an intermediate level to have different chunk file segments for the entire file, but it is difficult to verify performance.

The SplitStream method suggests a method of making a load between the nodes balanced by having each of peer nodes to be used as an internal node in a certain tree for only one file segment when configuring path trees for the delivery of each file segment. However, since the method of managing these trees is very complicated, the Split Stream method is inappropriate to be used in a dynamic P2P network environment.

The ChunkCast method is a locality-based indexing method for detecting a server peer located close to a client and having the largest quantity of file segments required by the client by using a ranking function. The ChunkCast method has the merit in the idea of using locality upon selecting a peer node or a file segment, but suggests no concrete measure of how to implement a ranking function.

In a conventional P2P file transfer method intends to transfer a file after configuring a bottleneck spot as an access link. Thus, it was difficult for the existing file transfer method to provide good performance under a network bottleneck spot.

The conventional P2P file transfer method focused on how to distribute files, but did not consider the selection of a proper peer, the selection of a distribution tree, the setting of a bandwidth, etc. To this end, the present applicant suggests a method of distributing files over a network in order to solve the problems of peer selection, chunk selection, distribution tree selection, and bandwidth allocation all at once.

### SUMMARY OF THE INVENTION

This object, according to the present invention, is achieved by a method comprising the steps of: forming a set of spanning trees between a transmitting node and receiving nodes and forming a minimum cost tree group by the sum of the link costs of links constituting each of the spanning trees; adjusting the transfer rate of each spanning tree belonging to the minimum cost tree group in accordance with the link cost of each spanning tree belonging to the minimum cost tree group; and transferring chunk files through the spanning trees whose transfer rate is adjusted.

Subsequently, the present invention minimizes the time taken for transferring a large file in a P2P environment. Further, the present invention can attain a proper balance of transfer rates among spanning trees located between the transmitting node and the receiving nodes because it computes an optimal set of distribution trees and their transfer rates with reference to the link costs between the transmitting node and the receiving node and distributes chunk files through the computed trees.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIGS. 1 and 2 are views conceptually showing a method of forming a minimum cost tree group in the present invention;

FIG. 3 is a flow chart of a method of distributing files over a network according to the present invention;

FIG. 4 is a view showing a tree transfer rate information message provided to a receiving node from a transmitting node;

FIG. 5 is a view showing a message about link cost information provided to the transmitting node from the receiving node; and

FIG. 6 shows chunk-tree information provided to the receiving node from the transmitting node.

### DETAILED DESCRIPTION OF THE PREFERRED EMBODIMENTS

Advantages and features of the present invention and a method of achieving the advantages and the features will be apparent by referring to embodiments described below in detail in connection with the accompanying drawings. However, the present invention is not limited to the embodiments disclosed below and may be implemented in various different forms. The exemplary embodiments are provided only for completing the disclosure of the present invention and for fully representing the scope of the present invention to those skilled in the art and the present invention is defined only by the appended claims. Like reference numerals designate like elements throughout the detailed description.

Hereinafter, the present invention will be described in detail with reference to the drawings.

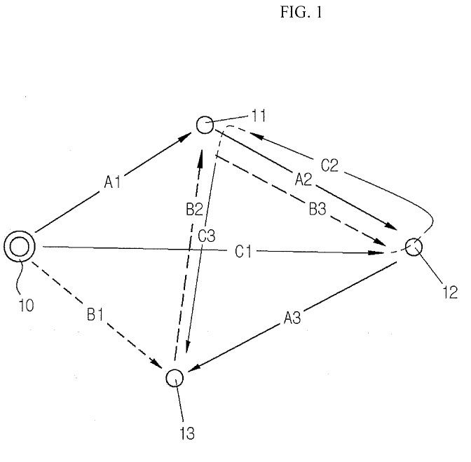

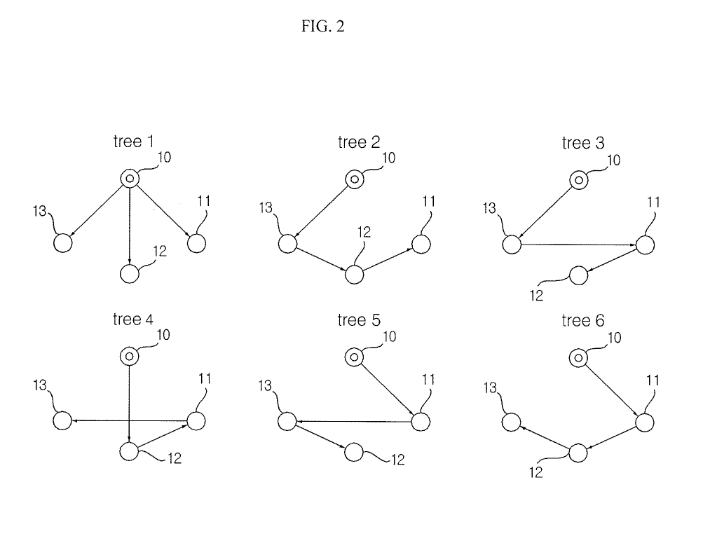

FIGS. 1 and 2 are views conceptually showing a method of forming a minimum cost tree group in the present invention.

Referring to FIG. 1, reference numeral 10 represents a transmitting node, and reference numerals 11, 12, and 13 represent receiving nodes for receiving chunk files from the transmitting node 10.

In the drawing, three spanning trees are illustrated. A spanning tree configured of links A1, A2, and A3, a spanning tree configured of B1, B2, and B3, and a spanning tree configured of C1, C2, and C3 are illustrated. One transmitting node 10 and three receiving nodes 11, 12, and 13 may form a total of 16 spanning trees.

FIG. 2 exemplifies 6 out of the 16 spanning trees, which shows a method in which the transmitting node 10 and the receiving nodes 11, 12, and 13 configure a spanning tree (trees 1˜trees 6) through various paths.

A spanning tree is formed for preventing looping generated by a circulation link. Therefore, the spanning tree is configured such that a tree structure is formed, passing the receiving nodes 11, 12, and 13 starting from the transmitting node 10, and the terminal end of the tree structure does not return to the transmitting node 10.

The three spanning tress (the first spanning tree formed of links A1, A2, and A3, the second spanning tree formed of links B1, B2, and B3, and the third spanning tree formed of links C1, C2, and C3. Each of the spanning tress (the first to third spanning trees) is configured of a set of links, and each link calculates the link cost. The link cost represents the congestion of the corresponding link. A high link cost means that the link is congested, while a low link cost means that the link is not congested.

Under the condition (one transmitting node and three receiving nodes) of FIG. 1, a spanning tree having the lowest sum of the link costs of links constituting each spanning tree is referred to as a minimum spanning tree. The spanning tree having the lowest sum of the link costs is referred to as a minimum spanning tree. With only one minimum spanning tree having the smallest sum of the link costs, an optimal transfer speed cannot be realized for packets directed to each of the receiving nodes 11, 12, and 13 from the transmitting node 10. Therefore, the present invention solves the problem of transfer speed by detecting two or more minimum spanning trees and grouping them.

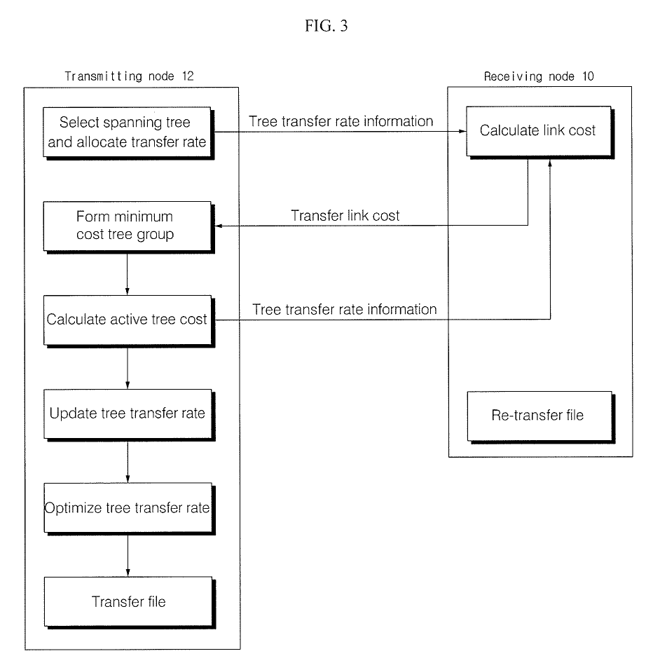

FIG. 3 is a flow chart of a method of distributing files over a network according to the present invention.

The transmitting node 10 exchanges necessary information with all the receiving nodes. For the brevity of explanation, we only show the interaction between the transmitting node 10 and the receiving node 12 in FIG. 3.

First, the transmitting node 10 forms a set of arbitrary spanning trees by combining links located between the transmitting node 10 and the set of receiving nodes, and allocates a target transfer rate to each of the spanning trees. The number of spanning trees initially used can be one or more than one.

Next, the transmitting node 10 allocates a transfer rate corresponding to the target transfer rate with respect to each of links constituting a spanning tree, and provides the receiving node 12 in charge of the links with the sum of transfer rates relative to a spanning tree passing through each link.

The receiving node 12 calculates the link cost of each link, and returns the calculated link cost to the transmitting node 10. The transmitting node 10 selects a spanning tree having the smallest sum of link costs among the arbitrarily formed spanning trees with reference to the link cost returned by the receiving node 12 and other receiving nodes, and has this spanning tree included in the minimum cost tree group.

Hereupon, the transmitting node 10 and the receiving node 12 set, as a minimum cost spanning tree, an active tree having the lowest link cost among the spanning trees corresponding to the tree group, obtains a ratio of the link costs of other active trees to the minimum cost spanning tree, and allocates different transfer rates to each of the active trees. If there is a difference in link cost between the minimum cost spanning tree and the active trees, the transfer rate to be allocated to the active trees is reduced. The larger the difference in cost, the greater the reduction in transfer rate. Here, the transfer rate allocated to each active tree is allocated in such a manner as to be burdened in the order of the active tree having the lowest link cost to the active tree having the highest link cost.

Typically, in a network, when the burden on any one active tree decreases, the burden on the surrounding other active trees increases. Thus, when the transfer rate of an active tree is changed, the transfer rate of the surrounding active trees is changed. Accordingly, the transmitting node 10 re-transmits transfer rate information on each active tree to the receiving nodes 11, 12, and 13 based on a state in which transfer rates are varied by comparison with the minimum cost spanning tree, and re-receives the link cost for each active tree from the receiving nodes 11, 12, and 13.

The receiving node 10 is able to re-calculate a minimum cost tree group with respect to spanning trees formed between the transmitting node 10 and the receiving nodes 11, 12, and 13. The transmitting node 10 re-calculates a minimum cost tree group until the cost of each active tree belonging to the re-calculated minimum cost tree group becomes similar. The similarity of tree costs among the active trees means that the load balance among the trees between the transmitting node 10 and the receiving nodes 11, 12, and 13 is achieved, and that the partition of transfer rates onto the active trees is optimal.

Next, the transmitting node 10 calculates a tree cost of each of the active trees corresponding to the minimum cost tree group. The tree cost is equal to the sum of the link costs of the links constituting the active tree. The transmitting node 10 updates the tree cost of each active tree in accordance with the calculated tree cost.

Next, the transmitting node 10 transfers a chunk file to the receiving node 12. Here, optimization is to burden the minimum cost spanning tree with transfer rates allocated to the active trees in accordance with the ratio of tree cost between the minimum cost spanning tree and the active trees, and then perform load balancing. At this time, the optimization of the transfer rate of each active tree can be carried out by the following equation 1.

link cost=qcₑ^{-q}xₑ^{q-1}

link scale factor=q(q−1)cₑ^{-q}xₑ^{q-2}, [Equation 1]

wherein q is a positive integer of two or more, cₑ is a link capacity, and xₑ is the sum of link transfer rates.

When Equation 1 is applied to the link cost, the time taken for repetitive calculation of the link cost is reduced.

If q=3,

c=100 Mbit/sec, and

x=20 Mbit/sec,

link cost=3×100⁻³×30⁻⁴=3.7037E-12 and

link scale factor=3×2×100⁻³×30⁻⁵=2.4691E-13

wherein the link cost and the link scale factor may have a different value according to a set value of q (two or more). That is, the value itself calculated by Equation 1 does not precisely represent a specific physical quantity. However, if Equation 1 is applied to various active trees, relative values can be obtained with respect to the respective active trees, and it can be judged clearly which active tree is more congested.

The link scale factor represents a speed at which the link cost increases when a value of the transfer rate xₑ to a link is increased by 1. The number itself does not have an absolute value, but represents a precise relative value when compared with other links and is used as an index for representing the rate of increase of the tree cost for each active tree. Here, the rate of increase of the tree cost is a numerical value representing how much the tree cost of the corresponding tree increases when the transfer rate of the active tree is increased by 1.

The reason why the link scale factor is used is to allow all the active trees to maintain a load balance by making the increasing the rate of link cost of all active trees equal to each other when the transfer rate of the active tree located between the transmitting node 10 and the receiving node 12 is adjusted by 1.

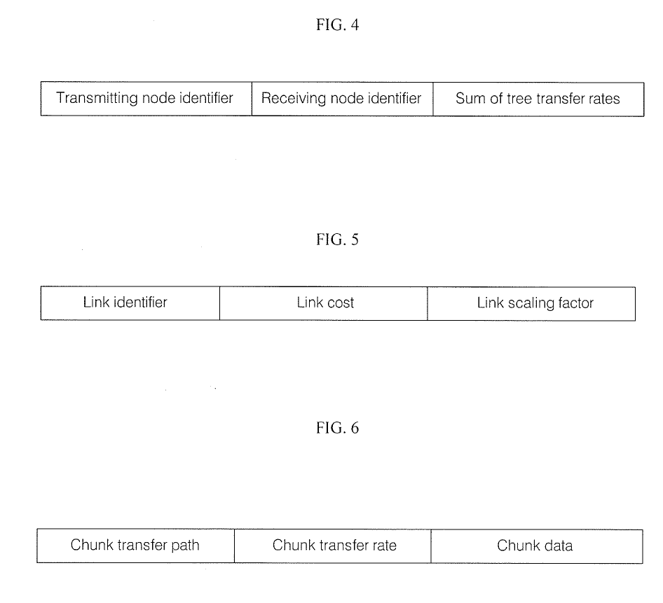

FIG. 4 is a view showing a tree transfer rate information message provided to a receiving node from a transmitting node.

The tree transfer rate information massage illustrated therein contains information about the identifier of the transmitting node 10, a link identifier, and the sum of tree transfer rates.

FIG. 5 is a view showing a message about link cost information provided to the transmitting node from the receiving node.

The link cost message illustrated therein contains a link identifier, a link cost, and a link scaling factor. The link scaling factor is calculated by Equation 1, and represents a value which is calculated by the receiving node 12 with the sum of tree transfer rates for each link and link capacities provided to the receiving node 12 from the transmitting node 10 and then is returned to the transmitting node 10.

FIG. 6 shows chunk-tree information provided to the receiving node from the transmitting node.

The chunk-tree information contains a delivery path of chunks to be transferred to the receiving node 12 from the transmitting node 10, a chunk transfer rate, and chunk data.

While the embodiment of the invention has been described with reference to the figures, it will be evident to those skilled in the art that the present invention may be embodied in other specific forms without departing from the spirit or essential characteristics thereof. The present embodiment is therefore to be considered in all respects as illustrative and not restrictive.

What is claimed is:

1. A method of distributing files over a network, comprising the steps of:
forming a set of spanning trees between a transmitting node and receiving nodes and forming a minimum cost tree group by the sum of the link costs of links constituting each of the spanning trees;
adjusting transfer rate of each spanning tree belonging to the minimum cost tree group in accordance with the link cost of each spanning tree belonging to the minimum cost tree group; and
transferring chunk files through the spanning trees whose transfer rate is adjusted.

2. The method of claim 1, wherein the step of forming a minimum cost tree group comprises the steps of:
forming arbitrary spanning trees between the transmitting node and the receiving nodes;
allocating a target transfer rate to each of the spanning trees;
receiving the link costs for the links through each of the receiving nodes forming the links;
the transmitting node's selecting a spanning tree having the smallest sum of link costs with reference to the link costs provided from the respective receiving nodes.

3. The method of claim 1, wherein the step of adjusting the transfer rate of each spanning tree comprises the steps of:
distributing a target transfer rate to each spanning tree belonging to the minimum cost tree group;
subtracting the target transfer rate allocated to the other spanning trees in accordance with a difference in link cost between the minimum cost spanning tree and the other spanning trees;
re-calculating the link cost for each link between the transmitting node and the receiving nodes; and
obtaining the minimum spanning tree set again in accordance with the re-calculated link cost.

4. The method of claim 1, wherein the step of transferring chunk files through the spanning trees whose transfer rate is adjusted further comprises the step of:
transferring chunk-tree information representing the size of the chunk files to be transferred to each spanning tree belonging to the minimum cost tree group and the path of links through which the chunk files pass.

5. The method of claim 4, wherein the chunk-tree information further comprises a chunk transfer rate and chunk data.

6. The method of claim 1, wherein the link cost is calculated by qcₑ^{-q}xₑ^{q-1},
wherein q is a positive integer of two or more, cₑ is a link capacity, and xₑ is the sum of link transfer rates.
